(19) United States
(12) Patent Application Publication
(10) Pub. No.: US 2026/0225748 A1
(43) Pub. Date: Aug. 6, 2026

(54) A MOVABLE MEMBER FOR A SYSTEM FOR SUPPORTING PRODUCTION OF PACKAGES, CORRESPONDING SYSTEM, FILLING MACHINE AND METHOD

(71) Applicant: TETRA LAVAL HOLDINGS & FINANCE S.A., Pully (CH)

(72) Inventors: Stefano FLORE, Modena (IT); Daniele CALTABIANO, Woodside, CA (US)

(73) Assignee: TETRA LAVAL HOLDINGS & FINANCE S.A., Pully (CH)

(21) Appl. No.: 19/153,063

(22) PCT Filed: Jan. 30, 2024
(86) PCT No.: PCT/EP2024/052143

§ 371 Date: Aug. 1, 2025

(30) Foreign Application Priority Data
Feb. 6, 2023 (IT) 102023000001899

(51) Int. Cl. B65B 9/207; B65B 9/12; B65B 51/30

(52) U.S. Cl. CPC B65B 9/207; B65B 9/12; B65B 51/30

(57) ABSTRACT

A movable member for a system for supporting production of packages from a tube of packaging material filled with pourable product is cyclically movable along a closed-loop path. The movable member comprises: a first and at least one second element, the at least one second element relatively movable with respect to the first element and comprising an actuator configured to engage with the packaging material forming the tube or the packages, a motor configured to move the at least one second element, a power receiver, connected to the motor, configured to receive power and transfer it to said motor, and at least one first movement sensor, positioned at the at least one second element and configured to generate a first sensor signal indicative of a movement of the at least one second element with respect to the first element.

### TECHNICAL FIELD

The present invention relates to a movable member for a (e.g. linear motor) system for supporting production of packages produced from a tube of packaging material filled with pourable (e.g. food) product. The movable member and corresponding system according to the instant invention may be used in industrial applications, e.g. in a filling machine at a forming, sealing and cutting station and/or at a final folding station.

### BACKGROUND ART

Systems comprising a track and movable members coupled thereto are known and used in industrial applications to improve efficiency and flexibility, such as linear motor systems or motor-driven chain systems. Such systems comprise a plurality of movable members movable along a path.

It is known the use of forming assemblies such as packaging assemblies comprising a plurality Of movable members movable (e.g. independently) from each other on tracks and configured to engage with, e.g. form, seal, cut, fold etc. packages made of sterilized packaging material configured to receive pourable food products, such as fruit juice, UHT (ultra-high temperature-treated) milk, wine, tomato sauce, etc.

These packages are normally produced in fully automatic packaging assemblies, in which a continuous tube is formed from a web of packaging material fed to such packaging assembly. The web is folded and sealed longitudinally to form the tube, which is fed along a vertical advancing direction. The tube is then filled with the sterilized food product from above and is sealed and subsequently cut along equally spaced transversal cross sections. To obtain the final package, the resulting package is then folded into the known final package shape.

Although being functionally valid, the known systems are still open to further improvement. A need is felt for an improved adaptability of the movable members to the need of the machine user, e.g. a change in the type of packaging material and/or dimensions of packages. In known systems, the movement of the actuators positioned on the movable members is done by means of a cam, accordingly it is fixed and it is not feasible to adapt real-time.

A need is felt for an improved control and monitoring of elements, e.g. actuating parts, of the movable members that are relatively movable with respect to each other. In an adaptable system with adaptable movable members, an improved precise control and monitoring of parts may facilitate improving an efficient and correct operation of the movable elements, e.g. actuators.

### SUMMARY OF THE INVENTION

It is therefore an object of the present invention to provide a movable member for a system for supporting production of packages from a tube of packaging material filled with pourable product, which can facilitate achieving one or more of the above-mentioned needs in a straightforward and low-cost manner. Such an object is achieved by means of a movable member according to claim 1 and corresponding system, filling machine and method having the features set forth in the claims that follow.

The disclosed embodiments may achieve one or more advantages, e.g.:
the movable members can be dynamically adapted to different machine user needs,
the movements of relatively movable parts of the movable members can be (precisely) monitored and controlled in real-time,
errors in the relative positioning of the elements of the movable members may be detected and adjusted, and/or
it is possible to measure, monitor and control and adapt key operations of the movable members, e.g. forming and sealing in case of a packaging assembly, directly on the movable members.

### BRIEF DESCRIPTION OF THE DRAWINGS

Embodiments of the present invention will be described by way of example with reference to the accompanying drawings, in which:

FIG. 1 is a schematic illustration of a detail of a movable member and a system according to one or more embodiments,

FIG. 2 is a non-limiting example of an exploded perspective view, with parts removed for clarity, of a movable member of a packaging assembly, and

FIG. 3 exemplifies a schematic front view, with parts removed for clarity, of a packaging assembly for forming a plurality of sealed packs according to the present invention.

### DESCRIPTION OF THE INVENTION

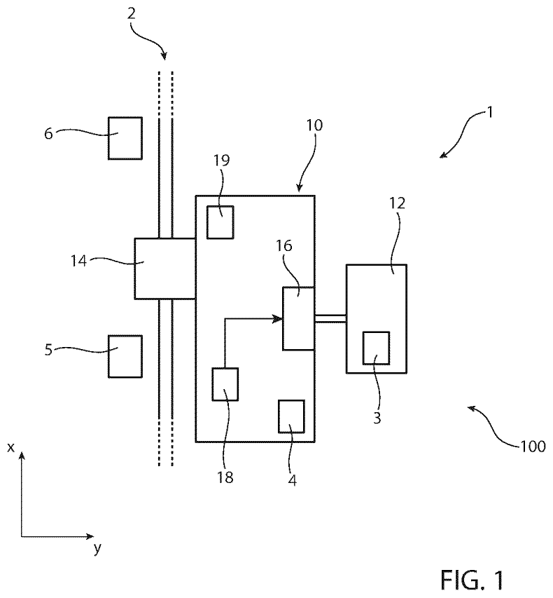

FIG. 1 illustrates an example of a movable member 1 according to one or more embodiments for a system for supporting production of packages from a tube of packaging material filled with pourable product. The movable member 1 is cyclically movable along a closed-loop path 2. The movable member 1 is preferably a mover or a cart. The movable member 1 is couplable to a track forming the closed-loop path 2, e.g. via a coupling element 14.

The movable member 1 comprises a first and one or more second elements 10, 12, with the second element 12 relatively movable with respect to the first element 10. The second element 12 comprises an actuator, e.g. a forming, sealing, cutting or folding element, configured to engage with the packaging material forming the tube or the packages. The actuator may come into contact with the packaging material, either in the form of the tube or in the formed of partially formed packages, as better described in the following. In particular, considering a Cartesian coordinate system XYZ as exemplified in the figures, the one Or more Second elements 12 may be rotatable about X, Y and/or Z axis. In addition or in alternative, the one or more second elements 12 may linearly move along X, Y and/or Z axis. In other words, the movements of the second element 12 may be linear, e. g. away or towards the first element 10, or angular, e.g. creating an angle with respect to the first element 10. The same remarks may apply also on the first element 10, that may be able to move or rotate in 3D.

In other words, the first and second element 10, 12 may comprise (e.g. mechanical) parts of the movable member 1. The first element 10 for example may comprise a main body of the movable member 1. The second element 12 may comprise a part coupled to said main body.

The movable member 1 further comprises a motor 16 configured to move the one or more second elements 12, and a power receiver 18, connected to the motor 16. The power receiver 18 is configured to receive, e.g. wirelessly, power and transfer it to the motor 16.

As exemplified herein for sake of simplicity only one second element 12 is visible, relatively movable with respect to the first element 10. It will be appreciated that the movable member 1 may comprise a plurality of second elements 12 movable by means of one or more motors 16. Such second elements 12 may be movable relatively with respect to the first element 10 as well as relatively with respect to one another. In case the movable member 1 comprises a plurality of second elements 12, the movable member may further comprise a plurality of first movement sensors 3 positioned at, preferably mounted on, the respective plurality of second elements 12.

Advantageously, thanks to the introduction of the motor 16 and the power receiver 18 it is possible to easily adapt the movement Of the actuator based on required parameters and/or desired package. Traditionally, the movement of the actuator was performed by means of cams fixed along the track forming the closed-loop path 2. For example, the system failed to dynamically adapt to the desired format changes.

The movable member 1 comprises at least one first movement sensor 3 configured to generate a first sensor signal indicative of a movement of the second element 12 with respect to the first element 10. The at least one first movement sensor 3 is positioned at the second element 12. In particular, the at least one first movement sensor 3 may be mounted on the second element 12, e.g. on a surface thereof.

Accordingly, the motor 16 may be configured to adjust a position and/or physical orientation of the second element 12 as a function of the first sensor signal.

The first sensor signal may be indicative of a position and/or a physical orientation of the second element 12 with respect to the first element 10.

Advantageously, monitoring the movement of the movable member 1 moving along the close-loop path 2 makes it possible to efficiently control such movement at any moment, even if the movement itself is not physically imposed by a cam.

In one or more embodiments, the movable member 1 may further comprise at least one second movement sensor 4, configured to detect a movement of the first element 10. The at least one second movement sensor 4 may be configured to generate a second sensor signal indicative of a deviation in position and/or physical orientation of the first element 10. The deviation in position and/or physical orientation may be indicative of a variation in the coupling of the movable member 1 to the track. In such cases, also the position and/or physical orientation of the second element 12 (attached to the first element 10) may be affected.

Advantageously, monitoring movement of the first element 10 in addition to the second element 12 may permit a more accurate control of the second element 12 and a more precise use of the actuator thereof. In other words, the first movement sensor 3 may permit a precise control of the second element 12, however the second movement sensor 4 may further improve such control insofar as it can compensate for the movement of the first element.

The at least one second movement sensor 4 may be positioned at the first element 10. In particular, the at least one second movement sensor 4 may be mounted on the first element 10, e.g. on a surface thereof.

The movable member 1 may comprise a processing unit 19, connected to the first and optionally second movement sensor 3, 4 and configured to receive the first and optionally second sensor signal, respectively, therefrom,

In one or more embodiments, the at least one first and/or second sensor 3, 4 may comprise an inertial sensor, preferably comprising a motion sensor and/or a rotation sensor. The inertial sensor may comprise MEMS accelerators such as Inertial Measurement Unit (IMU) comprising a 3D accelerometer and a 3D gyroscope with digital output. That is, the inertial sensor may comprise one or more motion sensor, such as (3D) accelerometers and/or one or more rotation sensors, such as (3D) gyroscopes.

A movement of the movable member 1 may be calculated by means of Inertial Navigation System (INS), calculating by dead reckoning a position, an orientation, and a velocity (direction and speed of movement) of the movable member 1 without the need for external references. By using the principles of inertial navigation, it is possible to monitor the relative motion (rotations and displacements) by integrating the sensors readings over time.

In addition or in alternative, the at least one first and/or second sensor 3, 4 may comprise at least one magnet and at least one magnetometer. The at least one magnet may be positioned at one of the first or second element 10, 12, and the at least one magnetometer, e.g. one or more Hall sensors or anisotropy magneto resistive (AMR) sensors may be positioned at the other of the first or second element 10, 12. The at least one magnet and at least one magnetometer may be positioned facing each other A variation in the magnetic field detected by the at least one magnetometer may be indicative of a movement of the second element 12 with respect to the first element 10.

The signal generated by the sensor may be indicative of a magnetic field at the one or more magnetometer, with the magnetic field measured changing as a function of the movement of the first and/or second element 10, 12.

An example of these types of sensors and the use thereof may be found in the description Of patent application EP4130911 A1 of the same Applicant.

FIG. 1 further shows a system 100 for supporting production of packages from a tube of packaging material filled with pourable product. The system 100 comprises a track, forming the closed-loop path 2, and a plurality of movable members 1 (only one movable member 1 is shown in the figure for simplicity) as previously discussed, the plurality of movable members 1 configured to cyclically move along the closed-loop path 2. The movable members 1 are coupled to the track.

The system 100 may comprise a power transmitter 5 configured to transfer power, e.g. wirelessly, to the power receiver 18. The power transmitter 5 may be positioned along at least a portion of the closed-looped path 2, preferably along the entire close-loop path 2.

In case of wireless power transfer, the power transmitter 5 and the power receiver 18 operate as transformer. The power transmitter 5 may comprise a primary coil configured to generate a varying electromagnetic field. The power receiver 18 may comprise a secondary coil, e.g. with an integrated rectifier. The varying electromagnetic field may induce power in the secondary coil.

In one or more embodiments, the system 100 may comprise a linear motor system. The closed-loop path 2 may be formed by an endless track. The plurality of movable members 1 may be movably coupled to the track and movable therealong independently from one another.

Permanent magnets arrangements and coils—i.e. movable members and a respective track—define such type of linear motors, which, in a known manner, are configured to independently control the movement Of the movable members along the respective track. The track may comprise a single rail or a plurality of rails. The rails can be closed in a racetrack configuration or they may be open.

In alternative to a linear motor system, the system 100 may comprise a motor-driven chain system. The system 100 may comprise a chain comprising a plurality of links. The chain may form the track. The chain may cyclically rotate along the closed-loop path 2.

The plurality of movable members 1 may be fixed to the chain, e.g. to different links thereof. Accordingly, the movable members 1 may move along the close-loop path 2 thanks to the rotation of the chain.

The system 100 may further comprise one or more processing units, e.g. the processing unit 19 of the movable member 1 and/or a system control and processing unit 6. The steps that will be described in the following can be performed by the processing unit 19 or the system control and processing unit 6, or a combination of the two processing units 19, 6.

The processing unit 19 of the movable member 1 may be configured to receive the first sensor signal from the at least one first movement sensor 3 and optionally the second sensor signal from the at least one second movement sensor 4. The processing unit 19 may be configured to transmit the sensor signals to the control and processing unit 6.

The control and processing unit 6 may be configured to adjust a position and/or physical orientation of the second element 12 as a function of the first sensor signal and optionally the second sensor signal.

The processing unit 19 and/or the control and processing unit 6 may be configured to calculate a movement, e.g. a position and/or a physical orientation, of the second element 12 with respect to the first element 10 as a function of the first sensor signal.

The processing unit 19 and/or the control and processing unit 6 may be configured to:
calculate a deviation in position and/or physical orientation of the first element 10 as a function of the second sensor signal, and
adapt (I.e. adjust or modify) the calculated position and/or a physical orientation of the second element 12 as a function of said deviation.

The control and processing unit 6 may be configured to perform one or more of:
interrupting operation of the movable members 1 and/or transmit an alert signal to a user interface, if the calculated position of the second element 12 differs from a predetermined position,
interrupting operation of the movable members 1 and/or transmit an alert signal to a user interface, if the calculated physical orientation of the second element 12 differs from a predetermined physical orientation.

The processing unit 19 of the movable member 1 may be coupled wirelessly to the system control and/or processing unit 6, which may be positioned at closed-loop path 2. For example, the processing unit 19 may be configured to transmit data to the system control and/or processing unit 6 at each cycle, when the respective movable member 1 passes thereat.

In industrial applications, the movable members 2 are configured to perform certain automatized operations, such as grabbing, cutting, forming, folding, applying objects etc. To perform the operation correctly, it is desirable that the position of parts of the movable members 1 is monitored. This is possible thanks to the first movement sensor 3 and optionally second movement sensor 4 which are configured to detect a movement of movable second element(s) 12 of the movable member 1 with respect to the first element 10.

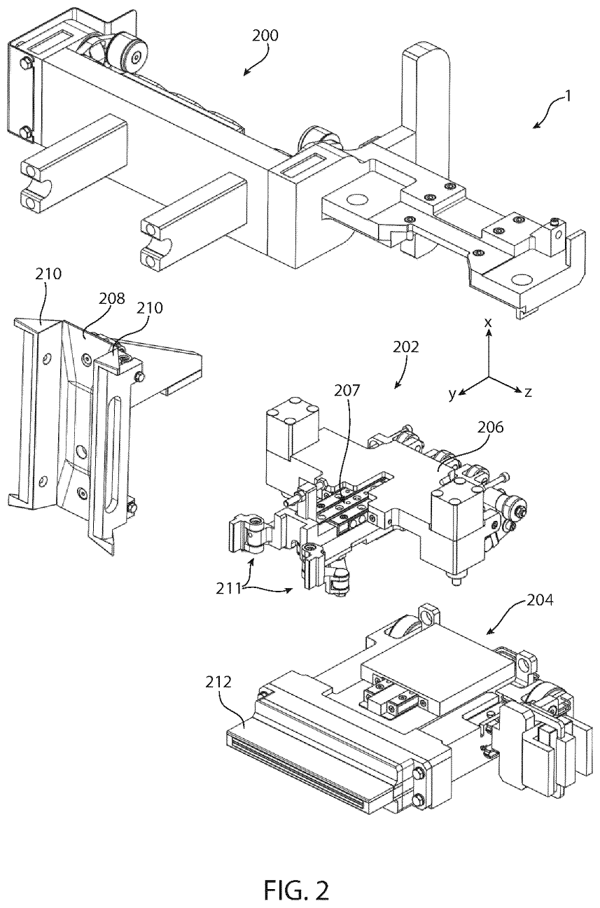

FIG. 2 exemplifies a movable member 1 of known type used in a packaging assembly for forming and sealing packages and is an exploded perspective view, with parts removed for clarity, of a movable member of such packaging assembly. This type of movable member 1 is described herein for clarity and easiness of understanding, however the movable member 1 is not to be interpreted as limited thereto. The movable member 1 may comprise a body 200 configured to couple to the track 2. The body 200 may be configured to slide over the track 2 along direction x, exemplified in FIG. 2. A forming unit 202 and a sealing unit 204 may be coupled, e.g. directly, to the body 200. The forming unit 202 may comprise a main body 206 and a movable element 207 configured to move along a second direction Y, orthogonal to the first direction X. The movable element 207 may be configured to move relatively to the main body 206 of the forming unit 202. The forming unit 202 may comprise a half-shell comprising a back wall 208 and flaps 210, connected directly or indirectly to movable element 207 of the forming unit 202. The forming unit 202 may further comprise hinges 211, connected to the flaps 210. The flaps 210 may be configured to rotate along an axis parallel to the first direction X.

The forming unit 202 may be configured to move, along the first direction X, relatively with respect to the sealing unit 204.

The sealing unit 204 may comprise a sealer 212 and may be configured to move along the second direction Y with respect to the body 200.

For non-limiting example, the first element 10 and the second element 12 may comprise:
the body 200 and the main body 207 of the forming unit 202,
the main body 206 and the movable element 207 of the forming unit 202,
the back wall 208 and the flaps 210,
the main body 206 of the forming unit 202 and the sealing unit 204,
the body 200 and the sealing unit 204.

For example, the motion sensor may be calibrated with respect to an initial reference coordinate system that may define the predetermined initial position. The rotation sensor may be configured to measure a signal indicative of angular motion. The processing unit 6, 19 may be configured to compensate the data collected by the motion sensors by means of the data collected by the rotation sensor. This way, the position calculated as a function of the sensor signal(s) can remain precise with respect to the initial reference coordination system.

For example, the processing unit 6, 19 may be configured to calculate the position and/or physical orientation of the second element 12 as a function of the sensor signal(s) indicative of an acceleration and/or indicative of an angular velocity detected by the inertial sensor(s). Thanks to the inertial sensors being positioned at the second and optionally first elements 12, 10, a precise control of the operation of the parts of the movable members 1 is possible. That is, the elements 12 configured to move to perform e.g. forming, sealing, folding or application of a package may be monitored. By means of the inertial sensors, errors in positioning of the elements 12 can be detected and corrected.

The one or more first and optionally second movement sensors 3, 4 may be potted with epoxy resin and fixed to the second element 12 and optionally first element 10, respectively. Advantageously, this way the inertial sensors may become virtually water and shock proof.

One or more embodiments may refer to a filling machine for producing packages 80 from a tube 8 of packaging material filled with pourable product, wherein the filling machine comprises the system 100 according to one or more embodiments. The system 100 may be used at different stations of the filling machine, e.g. at a forming, sealing and cutting station 7 and/or at a final folding station.

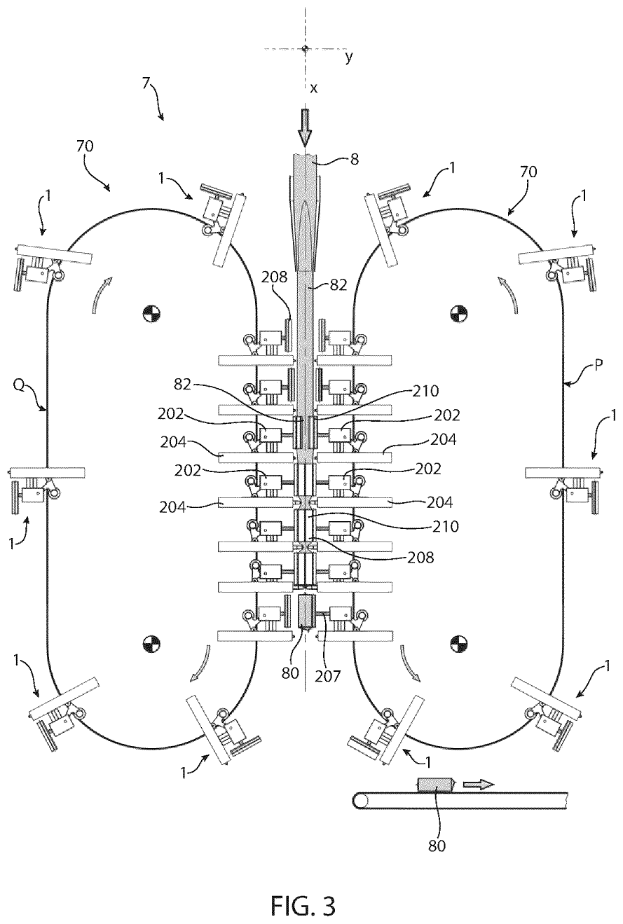

For ease of understanding, the forming, sealing and cutting station 7 is exemplified in FIG. 3. The station 7 may be configured to form a plurality of packages 80 and may comprise a pair of systems 100 according to one or more embodiments as previously described. In particular, the station 7 may comprise:
a pair of tracks 70 forming closed-loop paths P, Q;
at least a pair of movable members 1, each one of which movably coupled to a respective track 70 and cyclically movable along a respective path P, Q. the movable members comprising at least one second element 12. The at least one second element 12 of each movable member 1 is movable to support sealing, forming and/or cutting of the packages 80.

A tube 8 is formed in known manner by longitudinally folding and sealing a web (not shown) Of packaging material. Tube 8 is then filled from above by a pipe (not shown) with the pourable product and is fed through station 7 along a straight advancing direction X. In detail, tube 8 extends along a straight longitudinal, e.g. vertical, axis parallel to direction X.

The station 7 as exemplified in the figure comprises a linear motor system, however it can be implemented by means of a motor-driven chain system.

Each movable member 1, e.g. as exemplified in the exploded view of FIG. 2, of the pair of movable members 1 may comprise a respective forming unit 202 and optionally a respective sealing unit 204 linearly movable towards the tube 8, transversally to the advancement direction x, along direction Y, to cyclically cooperate in contact with successive tube portions 82, to form and optionally seal at least corresponding pack portions of respective packs 80, respectively.

As illustrated in FIG. 9, the two tracks 1 define respective endless paths P, Q arranged on opposite sides of the tube 8. More specifically, paths P, Q comprise:

In use, each movable member 1 cooperates with a corresponding movable member 1—i.e. movable members 1 mutually cooperates two by two—defining in this way a pair of movable members 1 facing each other and cooperating with one another and with tube 8 while sliding along the respective paths P, Q.

Each pair of movable members 2 is configured to cooperate with tube 8 to cyclically form and seal one respective pack 80 at a time, and cut the pack 80 to separate the pack 80 from tube 8.

To this end, each movable member 2 comprises, at one of its sides, the forming unit 202 and the sealing unit 204 both configured to cooperate with tube 8. The forming units 202 are configured to respectively cooperate with tube portions 82 of tube 8 to form at least corresponding pack portions, more in particular corresponding packs 80. For this purpose, each forming unit 202 is carried by, preferably mounted on, the respective movable member 2 in a movable manner. The forming unit 202 may preferably comprise a half-shell, presenting a C-shaped cross section and comprising a back wall 208 and a pair of lateral flaps 210. In the embodiment shown, flaps 210 are movably coupled to wall 208. The flaps 210 project from opposite lateral edges of wall 208 when movable members move along the paths P, Q.

In use, the half-shell of each forming unit 202 is configured to sequentially and cyclically cooperate in contact with tube portions 82 so as to form at least pack portions of respective packs 80.

Each half-shell is linearly movable transversally, e.g. orthogonally, to direction X, i.e. along direction Y, towards tube 8, i.e. towards the tube portion 82 that half-shell has to form. Each forming unit 202 comprises a movable element 207 linearly movable along direction Y, which carries a respective half shell.

Sealing units 204 are configured to cooperate with tube 8 to seal tube portions 82 at predetermined, equally spaced, successive cross sections crosswise to direction X. Furthermore, sealing units 204 are configured to cooperate with tube 8 to cut packs 80 at the cross sections, to separate packs 80 from one another.

On one side, each sealing unit 204 is mounted downstream of the corresponding forming unit 202 of the respective movable member 2 along the respective path P, Q and comprises a counter-sealing device and an extractable cutting element, for example a knife (not illustrated). On the other side, each sealing unit 204 is mounted downstream of the corresponding forming unit 202 of the respective movable member 2 along the respective path P, Q and comprises a sealing device and a seat, adapted to receive the knife of the corresponding sealing device configured to cooperate with such counter-sealing device. Sealing devices may comprise ultrasonic, induction or inductive heating sealing devices.

As shown in the figure, when forming units 202 and sealing units 204 are advanced by the respective movable members 2 along the paths P, Q, the respective half-shells, sealing devices and counter-sealing devices move back and forth along a direction Y between:
a closed position, or operative position, in which half-shells, sealing devices and counter-sealing devices cooperate with respective tube portions 82 to form, seal and cut respective packs 80; and
an open position, or idle position, in which half-shells, sealing devices and counter-sealing devices are detached from tube 8 or from the formed packs 80.

When half-shells are in the operative (closed) position, flaps 210 of each half-shell rotate about the respective hinges, e.g. about an axis parallel to direction X, from a position in which they diverge from the respective wall 208, to a position in which they are substantially orthogonal to the wall 208, face flaps 210 of the other half-shell carried by the corresponding movable member 2 of the same pair and contact tube 8 to completely surround the respective tube portion 82 destined to form the respective pack 80. When two half-shells of two respective forming units 202 of a pair of cooperating movable members 2 are both in the operative (closed) position, they define a substantially prismatic cavity and accordingly control the volume and shape of one respective pack 80 being formed.

When the counter-sealing device and sealing device of a pair of cooperating movable members 2 are in the operative (closed) position, they cooperate with one another to heat-seal tube 8, so as to form a top sealing band and a bottom sealing band. Then, the respective cutting element is extracted, so as to cut packs 80 between the top and bottom sealing band of two adjacent packs 80 and separate formed packs 80 from one another.

A further movement occurs along direction X, between the sealing unit 204 and the forming unit 202, to form a top and/or bottom of the packs 80.

The at least one first movement sensor 3 and optionally the at least one second movement sensor 4 may be positioned on the movable members 1 to monitor one or more of the aforementioned movements.

Accordingly, the first element 10 and/or the one or more second elements 12 may comprise the body 200 of the movable member 1, one or more components 206, 207, 208, 210 of the forming unit 202 and/or one or more components 204, 212 of the sealing unit 204.

As already discussed above, the filling machine may comprise the system 100 at a final folding station (not shown in the figures). The final folding station may be configured to fold semi-finalized packages 80 containing a pourable product fold, so-called pillow packages, into a final package, i.e. having the known final package shape. The final folding station may comprise a system 100 according to one or more embodiments, i.e. comprising:
a track forming a closed-loop path 2,
at least one movable member 1, coupled to the track and cyclically movable along the path 2, the movable member 1 comprising at least one second element 12, wherein the at least one second element 12 of each movable member is movable to support the final folding of the packages 80.

Again, the final folding station may be implemented by means of ant type of system, e.g. a linear motor system or a motor-driven chain system.

One or more embodiments may relate to a method of operating a movable member 1 for supporting production of packages 80 from a tube 8 of packaging material filled with pourable product. The method comprises:
providing at least one movable member 1 as previously described,
receive power at the power receiver 18,
power the motor 16 via the power received,
generate the first sensor signal indicative of a movement of the at least one second element 12 with respect to the first element 10,
drive the at least one second element 12 by means of the motor 16, preferably as a function of the first sensor signal.

The method may comprise one or more of the following steps:
adjusting a position and/or physical orientation of the second element 12 as a function of the first sensor signal and optionally the second sensor signal,
calculating a movement, e.g. a position and/or a physical orientation, of the second element 12 with respect to the first element 10 as a function of the first sensor signal.

The method may comprise:
calculating a deviation in position and/or physical orientation of the first element 10 as a function of the second sensor signal, and
adapting (I.e. adjust modify) the calculated position and/or a physical orientation of the second element 12 as a function of said deviation.

The method may comprise one or more of the following steps:
interrupting operation of the movable members 1 and/or transmit an alert signal to a user interface, if the Calculated position of the second element 12 differs from a predetermined position,
interrupting operation of the movable members 1 and/or transmit an alert signal to a user interface, if the calculated physical orientation of the second element 12 differs from a predetermined physical orientation.

1. A movable member for a system for supporting production of packages from a tube of packaging material filled with pourable product, the movable member cyclically movable along a closed-loop path, the movable member comprising:
a first and at least one second element, the at least one second element relatively movable with respect to the first element and comprising an actuator configured to engage with the packaging material forming the tube or the
a motor configured to move the at least one second element,
a power receiver, connected to the motor, configured to receive power and transfer it to said motor, and
at least one first movement sensor, positioned at the at least one second element and configured to generate a first sensor signal indicative of a movement of the at least one second element with respect to the first element.

2. The movable member according to claim 1, wherein the first sensor signal is indicative of a position and/or a physical orientation of the at least one second element with respect to the first element.

3. The movable member according to claim 2, wherein the motor is configured to adjust a position and/or physical orientation of the at least one second element as a function of the first sensor signal.

4. The movable member according to claim 1, further comprising at least one second movement sensor, configured to detect a movement of the first element.

5. The movable member according to claim 4, wherein the at least one second movement sensor is configured to generate a second sensor signal indicative of a deviation in position and/or physical orientation of the first element.

6. The movable member according to claim 1, wherein the first and/or at least one second movement sensor comprise:
an inertial sensor, or
at least one magnet and at least one magnetometer.

7. A system for supporting production of packages from a tube of packaging material filled with pourable product, the system comprising:
a track, forming the closed-loop path,
a plurality of movable members according to claim 1, the plurality of movable members coupled to the track and configured to cyclically move along the closed-loop path.

8. The system according to claim 7, comprising a power transmitter, positioned along at least a portion of the closed-looped path and configured to wirelessly transfer power to the power receiver.

9. The system according to claim 8, wherein the power transmitter comprises a primary coil configured to generate a varying electromagnetic field and wherein the power receiver comprises a secondary coil.

10. The system according to claim Z, wherein the track comprises an endless track and wherein the plurality of movable members are movable along the track independently from one another.

11. The system according to claim 7, comprising a chain comprising a plurality of links, wherein the chain forms the track and wherein the plurality of movable members are fixed to the chain.

12. Filling machine for producing packages from a tube of packaging material filled with pourable product, the filling machine comprising the system, according to claim 7.

13. Filling machine according to claim 12, comprising a forming, sealing and cutting station configured to form a plurality of packages and comprising a pair of the systems for supporting production of packages from a tube of packaging material filled with pourable product, the forming, sealing and cutting station comprising:
a pair of the tracks forming respective closed-loop paths,
at least a pair of the movable members, each one of which coupled to a respective track and cyclically movable along a respective path, the movable members comprising at least one second element wherein the at least one second element of each movable member is movable to support sealing, forming and/or cutting of the packages.

14. Filling machine according to claim 12, comprising a final folding station configured to fold semi-finalized packages containing a pourable product and comprising a system for supporting production of packages from a tube of packaging material filled with pourable product, the system comprising a track forming the closed-loop path and a plurality of movable members coupled to the track and configured to cyclically move along the closed-loop path, each of the plurality of movable members comprising: i) a first and at least one second element, the at least one second element relatively movable with respect to the first element and comprising an actuator configured to engage with the packaging material forming the tube or the packages; ii) a motor configured to move the at least one second element; iii) a power receiver, connected to the motor, configured to receive power and transfer it to said motor; and iii) at least one first movement sensor, positioned at the at least one second element and configured to generate a first sensor signal indicative of a movement of the at least one second element with respect to the first element, the final folding station comprising:
a track forming a closed-loop path;
at least one movable member, coupled to the track and cyclically movable along the closed-loop path, the movable member comprising at least one second element,
wherein the at least one second element of each movable member is movable to support the final folding of the semi-finalized packages.

15. A method of operating a movable member for supporting production of packages from a tube of packaging material filled with pourable product, the method comprising:
providing at least one movable member according to claim 1,
receive power at the power receiver,
power the motor,
generate the first sensor signal indicative of a movement of the at least one second element with respect to the first element, and
drive the at least one second element by motor.

16. The movable member according to claim 1, wherein the first and/or at least one second movement sensor comprise a motion sensor and/or a rotation sensor constituting an inertial sensor, or at least one magnet and at least one magnetometer.
